(19) United States
(12) Patent Application Publication
(10) Pub. No.: US 2011/0149906 A1
(43) Pub. Date: Jun. 23, 2011

(54) METHOD FOR REDUCING PACKET ORDERING TIME OF LAYER 3 HANDOVER AND MOBILE SATELLITE TERMINAL USING THE SAME

(75) Inventors: Hyun Ha HONG, Seoul (KR); Min Su Shin, Daejeon (KR); Dae Ig Chang, Daejeon (KR); Ho Jin Lee, Daejeon (KR)

(73) Assignee: ELECTRONICS AND TELECOMMUNICATIONS RESEARCH INSTITUTE, Daejeon-city (KR)

(21) Appl. No.: 12/850,332

(22) Filed: Aug. 4, 2010

(30) Foreign Application Priority Data
Dec. 21, 2009 (KR) 10-2009-0127728

(51) Int. Cl. H04W 4/00

(52) U.S. Cl. 370/331

(57) ABSTRACT

There are provided a method for reducing a packet ordering time of layer 3 handover and a mobile satellite terminal using the same. The method for reducing a packet ordering time of layer 3 handover of a mobile router in a home agent of a satellite network connected with the mobile router includes: transmitting a first packet and a second packet to the mobile router through a satellite link of the mobile router; transmitting a sequence control packet to the mobile router through the satellite link; and transmitting a third packet to the mobile router via a wireless link of the mobile router. The sequence control packet provides a reference time for rapidly reordering the second and third packets which reach the mobile router in a reverse sequence.

### CROSS-REFERENCE TO RELATED APPLICATIONS

This application claims priority under 35 U.S.C. §119 to Korean Patent Application No. 10-2009-0127728, filed on Dec. 21, 2009, in the Korean Intellectual Property Office, the disclosure of which is incorporated herein by reference in its entirety.

### BACKGROUND OF THE INVENTION

1. Field of the Invention

The present invention relates to a method for reducing a packet ordering time of layer 3 handover and a mobile satellite terminal using the same.

2. Description of the Related Art

With the development of satellite and wireless network technologies and increment of a user's request for supporting mobility, a mobile IP and a network mobility (NEMO) basic support protocol that extends the mobile IP appear in order to support a seamless service.

Since NEMO basic support (NBS) perform communication by using a bidirectional tunnel of a satellite link and a ground radio link between a mobile router (MR) and a home agent (HA), when a node (MNN: mobile network node) belonging to a mobile network performs communication with a correspondent node (CN), a packet performs tunneling through the home agent of the mobile router. Even though a fast MIP technology for rapid handover is applied to media independent handover (MIH), since a packet sequence is changed due to a transmission delay difference between a satellite network and a ground network and the packets are thus transmitted to the mobile router, the service is delayed in moving to a satellite shadow zone due to an increase of a packet reordering time.

### SUMMARY OF THE INVENTION

An object of the present invention is to provide a method capable of minimizing a packet ordering time by using an IPv4 Internet protocol based mobile network technology during handover from a satellite network to a wireless network.

Another object of the present invention is to provide a mobile satellite terminal capable of preventing a service delay even in a satellite shadow zone by reducing a packet ordering time in handover from a satellite network to a wireless network.

The objects of the present invention are not limited to the above-mentioned objects and other undescribed objects will be apparently appreciated by those skilled in the art from the following descriptions.

In order to solve the above-mentioned object, according to an aspect of the present invention, there is a method for reducing a packet ordering time of layer 3 handover of a mobile router in a home agent of a satellite network connected with the mobile router that includes: transmitting a first packet and a second packet to the mobile router through a satellite link of the mobile router; transmitting a sequence control packet to the mobile router through the satellite link; and transmitting a third packet to the mobile router via a wireless link of the mobile router, wherein the wireless link is activated in response to a registration request message of the mobile router moving from the satellite network to the wireless network. Herein, the sequence control packet provides a reference time for rapidly reordering the second and third packets which reach the mobile router in a reverse sequence.

The transmitting a sequence control packet may include generating the sequence control packet while performing the handover procedure and transmitting the generated sequence control packet to the mobile router before the satellite link is down.

The method for reducing a packet ordering time of layer 3 handover may further include forming a tunnel between the home agent and the mobile router via a foreign agent of the wireless network in accordance with a request of the mobile router. Further, the method for reducing a packet ordering time of layer 3 handover may include receiving the registration request message for the mobile router from the foreign agent and transmitting a registration response message to the foreign agent.

The sequence control packet may include a mobile IPv4 Internet protocol based structure.

According to another aspect of the present invention, there is a method for reducing a packet ordering time of layer 3 handover of from a satellite network to a wireless network in a mobile router with multiple interfaces for accessing the satellite network and the wireless network that includes: receiving a first packet and a second packet from a home agent of the satellite network through a satellite link; performing a mobile Internet protocol (MIP) registration procedure for the wireless network with moving from the satellite network to the wireless network; receiving a sequence control packet from the home agent through the satellite link during performing the MIP registration procedure; receiving a third packet from the home agent via a wireless link activated in the wireless network; and reordering the second and third packets that reach in a reversed sequence on the basis of a reception time of the sequence control packet.

The sequence control packet may include header and control information for controlling the sequence.

The method for reducing a packet ordering time of layer 3 handover may include forming a tunnel between the home agent and the mobile router via a foreign agent of the wireless network in accordance with a request of the mobile router. In this case, the method may include receiving a location-based trigger signal and a wireless link up trigger signal in the wireless link or transmitting a registration request message to the foreign agent and receiving a registration response message from the foreign agent.

According to yet another aspect of the present invention, there is a mobile satellite terminal that includes: a first interface forming a satellite link for transmission and reception of data in a satellite network; a second interface forming a wireless link for transmission and reception of data in a wireless network; a controller connected to the first interface and the second interface and processing the transmission and reception data in the satellite link or the wireless link; and a sequence control determinator detecting a sequence control packet received from the first interface during handover of from the satellite network to the wireless network. Herein, the controller reorders packet data which are received in a reverse sequence through the satellite network and the wireless network on the basis of a reception time of the sequence control packet.

The sequence control determinator may include: a network handover determining unit determining the handover; and a sequence control packet detecting unit detecting the sequence control packet among packet data received in the first interface in accordance with the network handover determining result.

The controller may include a buffer temporarily storing the packet data received from the wireless link during handover of from the satellite network to the wireless network.

The controller may sequentially process the packet data stored in the buffer from the reception time of the sequence control packet.

The controller may form a tunnel between the mobile router and the home agent via the wireless link and turn down the satellite link from an activation state to an inactivation state in accordance with a satellite link down trigger signal received from the satellite link. In this case, the controller may perform discovery and registration procedures for the foreign agent of the wireless network in accordance with a location-based trigger signal and a wireless link up trigger signal received from the wireless link. Further, the controller may transmit a registration request message to the foreign agent and receive a registration response message from the foreign agent.

The mobile satellite terminal according to the embodiment of the present invention may further include an input/output interface connected to the controller, transmitting the packet data transmitted from the satellite link or the wireless link to a fixed node, receiving the packet data from the fixed node, and transmitting the received packet data to a first or second interface in accordance with a control of the controller.

According to an embodiment of the present invention, by applying a fast packet ordering technology using a sequence control packet when a mobile satellite terminal, that is, a device having a mobile router and a fixed node moves from a satellite network to a wireless network, a service can be continued without reversing a packet sequence between communication nodes without changing a home of address (HoA) of the mobile satellite terminal or the fixed node. That is, it is possible to reduce a packet ordering time during handover and thus, it is possible to prevent a service delay even in a satellite shadow zone.

Further, when a mobile satellite terminal having multiple interfaces moves from the satellite network to the wireless network which is the satellite shadow zone, reordering is rapidly performed for packet inputted from the satellite network and the wireless network in a reverse sequence by using a sequence controlling packet received from the satellite network instead of the prior art such as a policy enforcement point (PEP), etc., such that the service can be used with a low packet delay with respect to a session connected to the fixed node even under a satellite shadow environment.

In addition, according to an embodiment of the present invention, by processing a packet ordering control operation without delay when the mobile satellite terminal moves to the satellite shadow zone, it is possible to prevent a service delay due to packet ordering at the time of applying multi-interface-based handover between heterogeneous networks and to provide or use a satellite multimedia service with a low delay even in a small-capacity packet buffer.

### BRIEF DESCRIPTION OF THE DRAWINGS

FIG. 1 is a schematic block diagram for describing a satellite and wireless interworking network system configuration and handover of a mobile satellite terminal according to an embodiment of the present invention;

FIG. 2 is a flowchart showing a method for reducing a packet ordering time in handover between a satellite network and a wireless network according to an embodiment of the present invention;

FIG. 3 is a schematic block diagram of a mobile satellite terminal according to an embodiment of the present invention;

FIG. 4 is a schematic block diagram of a sequence control determinator of FIG. 3; and

FIG. 5 is a schematic block diagram of a sequence control packet structure according to an embodiment of the present invention.

### DETAILED DESCRIPTION OF THE PREFERRED EMBODIMENTS

Hereinafter, preferred embodiments of the present invention will be described in detail with reference to the accompanying drawings and contents to be described below. However, the present invention is not limited to embodiments described herein and may be implemented in other forms. The embodiments introduced herein are provided to fully understand the disclosed contents and fully transfer the spirit of the present invention to those skilled in the art. Like elements refer to like reference numerals throughout the specification. Meanwhile, terms used in the specification are used to explain the embodiments and not to limit the present invention. In the specification, a singular type may also be used as a plural type unless stated specifically. “Comprises” and/or “comprising” used the specification mentioned constituent members, steps, operations and/or elements do not exclude the existence or addition of one or more other components, steps, operations and/or elements.

The present invention relates to a method for reducing a packet ordering time in media independent handover and a mobile satellite terminal using the same. Handover between a satellite network and a wireless network is described as an example. But the present invention is not limited thereto. Further, a case in which a mobile router includes a satellite network interface and a mobile network interface accessible to the satellite network and the mobile network, respectively to operate by accessing the satellite network in a satellite visible area and accessing in a shadow area where a satellite signal is not received will be described as an example. Further, for ease of description, a case in which a home network is the satellite network and a foreign network is the wireless network will be described as an example.

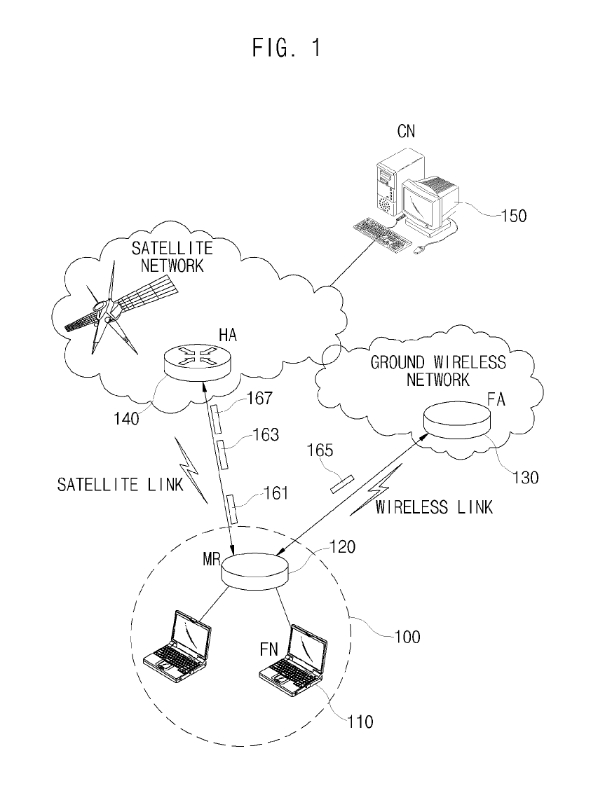

FIG. 1 is a schematic block diagram for describing a configuration of a satellite and wireless interworking network system and handover of a mobile satellite terminal according to an embodiment of the present invention.

Referring to FIG. 1, the satellite and wireless interworking network system includes a satellite network, a ground wireless network (hereinafter, referred to as ‘wireless network’), or a fixed node (FN) 110 and a correspondent node (CN) 150 that are connected with each other to communicate with each other through the wireless network and the satellite network.

At least one fixed node 110 is connected to one mobile router 120. The fixed node 110 and the mobile router 120 may form a mobile node or a mobile network (MN) 100. The correspondent node 150 may include another fixed node performing data exchange on the mobile network 100 and an IPv4 Internet protocol.

The mobile router 120 may be integrally modularized with any one fixed node 110. In this case, the mobile router 120 corresponds to the mobile network 100 having at least one fixed node 110. The mobile network 100 may be implemented as, for example, the mobile satellite terminal.

In the following description, the fixed node 110 of which the Internet protocol (IP) address or the point of attachment (PoA) cannot be changed without terminating an already opened session includes a fixed host or a fixed router itself or a component including the same. In addition, the mobile router 120 is called a dynamic host or a dynamic router itself capable of dynamically changing the PoA while connecting the mobile network 100 and the satellite network, the wireless network, the Internet, or a combination network thereof to each other, or a component including the same.

Further, the satellite and wireless interworking network system includes a home agent (HA) 140 positioned on the satellite network and a foreign agent (FA) 130 positioned on the wireless network. Each of the mobile network 100 and the correspondent node 150 may be connected with the wireless network via the home agent 140 or connected with the satellite network via the foreign agent 130.

The satellite network includes a communication network that can provide a bidirectional Internet service on the basis of the second generation digital video broadcasting (DVB-S2) or return channel via satellite (RCS).

The home agent 140 serves as an access router of the mobile network 100 to the satellite network and may be positioned at a fixed terminal station or a mobile terminal station on the ground. When the home agent 140 is positioned at the mobile terminal station, the home agent 140 can provide a satellite Internet service to a high-speed moving body such as a high-speed train.

The wireless network as a communication network based on a wireless LAN or wireless broadband (WiBro) may include a base station (BS) or an access station. The access station may correspond to the fixed or mobile terminal station of the satellite network.

The foreign agent 130 provides a high-speed Internet service to the mobile network 100 on the basis of the Internet protocol when the mobile network 100 moves during handover from the satellite network to the wireless network. The Internet protocol may adopt IPv4. The foreign agent 130 is a wireless network access router to the mobile router 120. In the embodiment, the foreign agent 130 is connected with the mobile router 120 as a bidirectional link via a wireless link.

In the above-mentioned satellite and wireless interworking network system, when the mobile network 100 is moving during the handover from the satellite network to the wireless network as a satellite network based multimedia Internet service is generalized, a technology is required, which maintains a service with a low packet delay with respect to a session that is in connection even under a satellite shadow environment by rapidly correcting a reverse packet sequence generated due to a delay time difference in internetwork transmission of packets 501, 503, and 507.

For this, in the embodiment, by interworking the satellite network and the wireless network by using a mobile Internet protocol (MIP) technology and applying a fast packet ordering technology using a sequence control packet 505 to the mobile router 120 provided in the mobile network 100, the reverse packet sequence is rapidly corrected to provide the wireless Internet service to a lower fixed node 110 with the low packet delay even in a satellite shadow zone.

That is, in the embodiment, the mobile router 120 has multiple interfaces capable of accessing the satellite network and the wireless network. and the mobile router 120 operates by accessing the satellite network which is the home network in a satellite visible zone, and accessing the wireless network which is the foreign network on the basis of MIP of a layer 3 in order to prevent a service interruption in a shadow zone where a satellite signal is not present, that is, in the case of handover from the satellite network to the wireless network, the packet sequence is corrected by additionally transferring the sequence control packet 167 to the mobile router 120.

A handover process of a mobile satellite terminal in the above-mentioned satellite and wireless interworking network system will be described below.

First, when the mobile network 100 enters the satellite shadow where the service through the satellite link is invalid, the home agent 140 and the mobile router 120 are disconnected from each other on the satellite network and the mobile network 100 is allocated with a care-of-address (CoA) from the wireless network, such that a new tunnel is formed between the home agent 140 and the mobile router 120 via the foreign agent 130. Therefore, the fixed node 110 connected to the mobile router 120 can continue the seamless Internet service with the correspondent node 150 without changing the home of address (HoA) which is the fixed IP address.

Thereafter, when the mobile satellite terminal, that is, the mobile network 100 can access the satellite network, the above-mentioned tunnel through the wireless network is cancelled and the fixed node 110 performs Internet communication with a correspondent 150 by using the HoA which is the original fixed IP address through the satellite link between the mobile router 120 and the home agent 140.

Meanwhile, as shown in FIG. 1, when a first packet 161, a second packet 163, and a third packet 165 are in sequence transferred from the fixed node 110 to the home agent 140, and the mobile network 100 is handed over from the satellite network to the wireless network, the first packet 161 and the second packet 163 may be transferred from the home agent 140 to the mobile router 120 through the satellite link and the third packet 165 may be transferred from the home agent 140 to the mobile router 120 through the wireless link.

That is, when the packets are transferred between the home agent 140 and the mobile router 120 during the handover of the mobile network 100, the sequence of the packets that reaches the mobile router 120 may be reversed due to the delay time difference between the satellite network and the wireless network. In other words, in transferring the packets, the delay time in the satellite network is comparatively larger than that in the current wireless network. Therefore, although the second packet 163 and the third packet 165 depart from the home agent 140 in sequence, the third packet 165 may reach the mobile router 120 earlier than the second packet 163. In this case, the sequence of the packets received by the mobile router 120 is reversed.

When the sequence of the packets in media independent handover is reversed, a prestored policy is performed by a policy enforcement point (PEP) by the existing method. As the existing policy, there may be used for example, a method of selectively retransmitting packets that are not normally received during the handover.

In the embodiment, in order to rapidly correct the reversed packet sequence, the mobile router 120 rapidly reorders the previously received packets by using the sequence control packet 167 additionally received from the home agent 140 and transfers the reordered packets to the fixed node 110.

It is preferable that the sequence control packet 167 is generated by the home agent 140 and then transmitted to the mobile router 120 through the satellite network just after the second packet 163 is transmitted. However, in another embodiment, the sequence control packet 167 may be generated by the home agent 140 and transmitted to the mobile router 120 via the foreign agent 130 of the wireless network prior to transmitting the third packet.

Hereinafter, a process of reducing the packet ordering time by performing packet ordering by using the sequence control packet will be described in more detail.

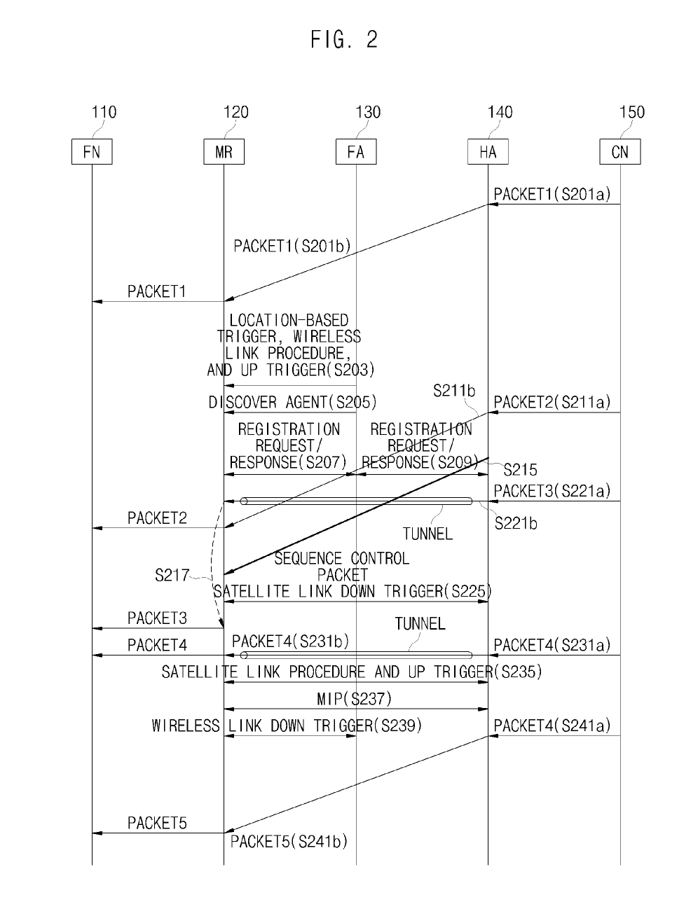

FIG. 2 is a flowchart showing a processing procedure capable of reducing a packet ordering time during handover between a satellite network and a wireless network according to an embodiment of the present invention.

In FIG. 2 shows a fast packet ordering processing procedure in mobile IPv4-based handover of a mobile router (MR) 120 between satellite and wireless networks.

Referring to FIG. 2, the mobile router 120 accesses the home agent 140 through a satellite link on the satellite network which is a home network. A fixed node 110 and a correspondent node 150 are connected to the home agent 140. The fixed node 110 receives first packet (packet 1) data of which the destination address is a HoA which is a fixed home IP address of the fixed node from the correspondent node 150 (S201a, S201b, and S201c).

When a mobile satellite terminal enters a satellite shadow zone, the mobile router 120 performs a mobile Internet protocol (MIP) procedure for forming a wireless link with a foreign agent (FA) 130 with respect to a newly accessed wireless network.

For example, when a wireless link up trigger for a wireless link procedure is generated in a wireless link layer of the mobile router 120, a wireless link access procedure in the mobile router 120 is performed (S203). That is, the mobile router 120 transmits an agent request message to the foreign agent 130 and receives an agent advertisement message from the foreign agent 130 to perform an agent discovery procedure (S205). In addition, the mobile router 120 performs an MIP registration procedure.

Meanwhile, the home agent 140 transmits second packet (packet 2) data received from the correspondent node 150 during the MIP registration procedure or before completion of the MIP registration procedure to the mobile router 120 through the satellite link (S211a and S211b). When the MIP registration procedure via the foreign agent 130 is completed after the second packet is transmitted, the home agent 140 generates a sequence control packet and additionally transmits the sequence control packet to the mobile router 120 through the satellite link following the second packet before the satellite link is down (S215).

When the MIP registration procedure via the foreign agent 130 is completed, a new tunnel 223 is formed between the home agent 140 and the mobile router 120. After the MIP registration, third packet (packet 3) data that departs from the correspondent node 150 is transmitted from the home agent 140 to the mobile router 120 through the tunnel 223 (S221a and S221b).

At this time, the second packet data transmitted from the home agent 140 to the mobile router 120 through the satellite network reaches the mobile router 120 later than the third packet data transmitted from the home agent 140 to the mobile router 120 via the foreign agent 130 of the wireless network because of a satellite link's transmission delay comparatively later than the wireless link. Therefore, the mobile network 100 according to the embodiment rapidly reorders the packets that reach the mobile router 120 by using the sequence control packet.

The sequence control packet is preferably transmitted to the mobile router 120 at the same time as registration request and response procedures among the MR, FA, and HA through a ground network is terminated and the second packet is lastly transmitted through the satellite link. Thereafter, third packet and packets following the third packet are transmitted from the home agent 140 to the mobile router 120 through the tunnel.

Meanwhile, the mobile router 120 stores, in a buffer, packet data transmitted through the wireless link after the MIP procedure for the handover from the satellite network to the wireless network is started. In addition, the mobile router 120 transmits, to the fixed node 110, packet data received through the satellite link before the satellite link is down in the L3 handover as it is. In the embodiment, the mobile router 120 transmits, to the fixed node 110, the second packet data received through the satellite link before the satellite link is down as it is. At this time, the mobile router 120 checks whether the sequence control packet reaches through the satellite link. When reception of the sequence control packet through the satellite link is verified, the mobile router 120 sequentially transmits the packet data sequentially stored in the buffer to the fixed node 110 following the second packet data that lastly reaches prior to the handover.

In other words, in the embodiment, after the mobile router 120 stores, in the buffer, the third packet data that reaches through the wireless link earlier than the second packet data that reaches through the satellite link during the handover from the satellite network to the wireless network, the mobile router 120 first transmits the second packet data to the fixed node 110 and thereafter, transmits the third packet data to the fixed node 110 in response to reception of the sequence control packet that reaches following the second packet data (S217).

Next, the satellite link between the mobile router 120 and the home agent 140 is inactivated in response to a satellite link down trigger signal generated in a satellite link layer of the mobile router 120 (S225). In addition, fourth packet (packet 4) data that departs from the correspondent node 150 is transmitted to the fixed node 110 through the tunnel connecting the home agent 140 and the mobile router 120 via the foreign agent 130 (S231a and S231b).

Thereafter, when the mobile satellite terminal or the mobile network 100 is handed over from the wireless network to the satellite network, an MIP procedure for activating the satellite link between the home agent 140 and the mobile router 120 is performed (S235 and S237). Herein, the MIP procedure includes a satellite link procedure for discovering an agent of the satellite network in accordance with a satellite link up trigger signal indicating the start of the satellite link procedure and registering the mobile router 120 in the agent.

After the MIP procedure for the satellite link is completed, the wireless link down trigger signal is generated in the wireless link layer of the mobile router 120 (S239). The wireless link between the mobile router 120 and the foreign agent 130 is inactivated in accordance with the wireless link down trigger signal.

Fifth packet (packet 5) data transmitted from the correspondent node 150 to the home agent 140 is transmitted to the mobile router 120 through the satellite link (S241a and S241b). In addition, the fifth packet data is transmitted from the mobile router 120 to the fixed node 110. At this time, since there is no concern that the packet sequence between the fifth packet data transmitted from the correspondent node 150 to the fixed node 110 and other packet data that reach the mobile router 120 before and after the fifth packet data reaches will be reversed, the packet ordering control of the embodiment required due to the transmission delay of the satellite network needs not to be applied.

As described above, in the mobile satellite terminal, the packet reordering procedure is required because the sequence of the received packets in the mobile network 100 is reversed due to the transmission delay of the satellite network when the handover from the satellite network to the wireless network occurs, but in the embodiment, it is possible to reduce the packet ordering time even during the handover in media independent handover by performing the packet ordering procedure using the sequence control packet instead of the prior art such as the PEP, thereby preventing a delay of the satellite Internet service, etc. Moreover, by reducing the packet transmission delay, it is possible to save even the packet buffer in the mobile satellite terminal.

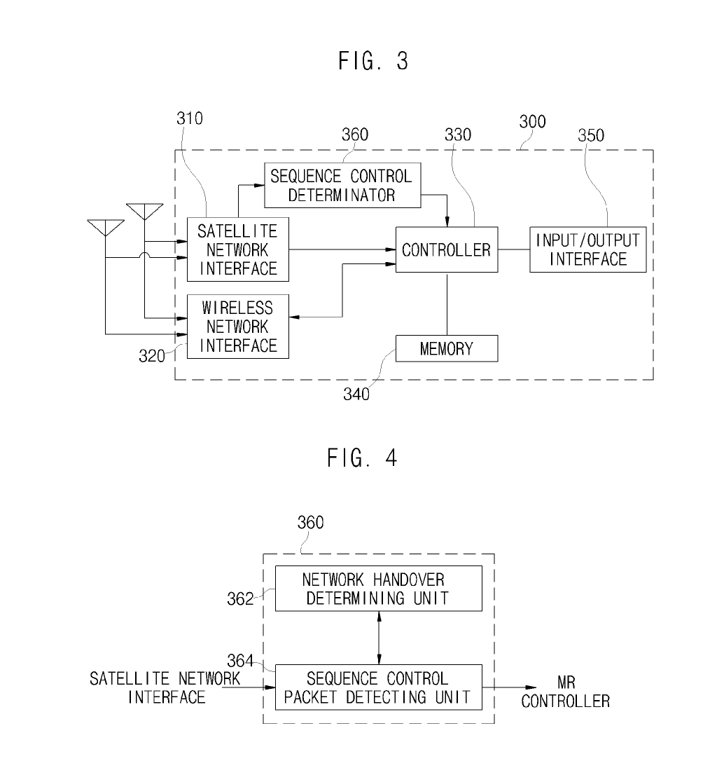

FIG. 3 is a schematic block diagram of a mobile satellite terminal according to an embodiment of the present invention.

Referring to FIG. 3, the mobile satellite terminal 300 includes a satellite network interface 310, a wireless network interface 320, a controller 330, a memory 340, an input/output interface 350, and a sequence control determinator 360.

The mobile satellite terminal 300 according to the embodiment may include the mobile router 120 described above with reference to FIG. 1 as the mobile router. For example, the mobile router includes a router mounted on a high-speed train so as to connect a fixed node installed in the high-speed train to a satellite network. Herein, the fixed node includes a portable terminal, a personal computer, etc. that are wirelessly communicatable.

That is, when a mobile satellite terminal 300 is handed over from the satellite network to a wireless network, the mobile router of the embodiment sequentially stores packet data received through a wireless link in a buffer or a memory in sequence, first processes packet data received through a satellite link and thereafter, processes the packet data stored in the buffer or memory on the basis of a reception time of a sequence control packet that reaches lastly through the satellite link and is detected by the sequence control determinator 360.

The satellite network interface 310 is called a module that transmits and receives data through the satellite link connected to the satellite network or a function unit including the module. For example, the satellite network interface 310 modulates and transmits data in a method such as wideband code division multiple access (W-CDMA) and demodulates and receives data in a method such as digital video broadcasting-satellite (DVB-S).

The wireless network interface 320 is called a module that transmits and receives data through a wireless link connected to the wireless network or a function unit including the module. For example, the wireless network interface 320 modulates and transmits data in the method such as the W-CDMA and demodulates and receives data in the method such as W-CDMA. Hereinafter, the satellite network interface 310 is called a first interface and the wireless network interface 320 is called a second interface.

The controller 330 provides spaces for a memory region required for an operation of the mobile satellite terminal and a buffer used to process data. In the embodiment, the controller 330 may include a data processor (not shown) that demodulates MPEG-2 data on the DVB-S transmitted through a forward link. The memory 340 provides a storage space of an operating system for operating devices.

Further, the controller 330, which is connected with the memory 340, controls receiving and processing the data transmitted through the forward link via a satellite and controls converting data required by a user into transmission data and transmitting the converted transmission data to the satellite through a reverse link.

The input/output interface 350 may include a display (not shown) and an external interface (not shown). The display may output information including conditions of devices, etc. in a 7-segment form. The external interface may include a serial communication unit (not shown) providing a serial communication interface of the maximum 1 Mbps, an Ethernet (not shown) providing a 10 base-T Ethernet interface, and an analog audio and video interface (not shown) providing an analog video/audio interface for satellite broadcasting.

The sequence control determinator 360 detects the sequence control packet received from the satellite link to the first interface 310 while performing the MIP registration procedure for the wireless link when the mobile satellite terminal 300 moves from the satellite network to the wireless network. In addition, the sequence control determinator 360 reorders packet data received through the satellite network and the wireless network on the basis of the reception time of the sequence control packet and transmits the reordered packet data to the corresponding fixed node.

FIG. 4 is a schematic block diagram of a sequence control determinator of a mobile satellite terminal of FIG. 3.

Referring to FIG. 4, the sequence control determinator 360 includes a network handover determining unit 362 and a sequence control packet detecting unit 364.

The network handover determining unit 362 determines whether or not an MIP procedure for layer 3 handover is performed when the mobile satellite terminal 300 or the mobile network (see 100 of FIG. 1) moves from the satellite network to the wireless network. The network handover may be determined based on generation of an agent request message for discovering the foreign agent or generation of a request message for agent registration.

The sequence control packet detecting unit (hereinafter, in brief, referred to as ‘detecting unit’) 364 receives information on the network handover from the network handover determining unit 362 and detects the sequence control packet from the packet data received from the first interface in accordance with the network handover information. The detected sequence control packet is transmitted to the controller of the mobile router.

According to the embodiment of the present invention, when the mobile satellite terminal or the mobile network 100 is handed over from the satellite network to the wireless network, the mobile router (see 120 of FIG. 1) sequentially stores packet data received through a wireless link in a buffer or a memory in sequence, first processes packet data received through a satellite link and thereafter, processes the packet data stored in the buffer or memory on the basis of a reception time of a sequence control packet that reaches lastly through the satellite link and is detected by the sequence control determinator 360.

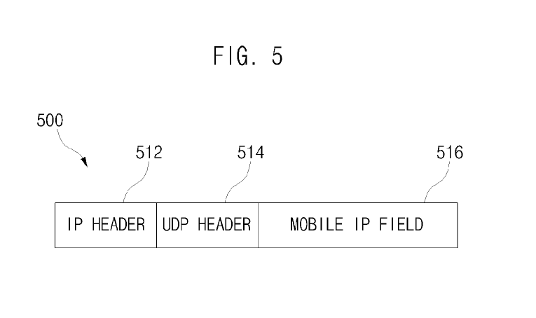

FIG. 5 is a schematic block diagram of a structure of a sequence control packet according to an embodiment of the present invention.

Referring to FIG. 5, the sequence control packet 500 includes an IP header 512, a UDP header 514, and a mobile IP field 516. The IP header 512 includes a source IP address and a destination IP address. The source IP address includes an address of the home agent and the destination IP address includes a HoA of the mobile router. The UDP header 514 includes a variable source port number and a destination port number. The destination port number includes a source port of the corresponding registration request message. The mobile IP field 516 includes an 8 bit-type field and includes a predetermined value x defined in the type field. Herein, the predetermined value x represents Registration Complete, that is, completing the handover procedure to the wireless network and transmitting the last packet to the satellite network.

The sequence control packet 500 of the embodiment as the packet for reordering the packet data that reaches in a reverse sequence during layer 3 handover is implemented using a user datagram protocol (UDP)-based mobile IP packet. That is, the type field (8 bit) of the mobile IP packet is newly defined by the predetermined value x to be implemented without influencing the existing protocol.

An optimal embodiment of the present invention is disclosed through a detailed description and drawings as described above. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method for reducing a packet ordering time of layer 3 handover of a mobile router in a home agent of a satellite network connected with the mobile router, comprising:
transmitting a first packet and a second packet to the mobile router through a satellite link of the mobile router;
transmitting a sequence control packet to the mobile router through the satellite link; and
transmitting a third packet to the mobile router via a wireless link of the mobile router, the wireless link being activated in response to a registration request message of the mobile router moving from the satellite network to the wireless network,
wherein the sequence control packet provides a reference time for rapidly reordering the second and third packets which reach the mobile router in a reverse sequence.

2. The method for reducing a packet ordering time of layer 3 handover of claim 1, wherein the transmitting a sequence control packet includes generating the sequence control packet while performing the handover procedure and transmitting the generated sequence control packet to the mobile router before the satellite link is down.

3. The method for reducing a packet ordering time of layer 3 handover of claim 2, further comprising forming a tunnel between the home agent and the mobile router via a foreign agent of the wireless network in accordance with a request of the mobile router.

4. The method for reducing a packet ordering time of layer 3 handover of claim 3, further comprising receiving the registration request message for the mobile router from the foreign agent and transmitting a registration response message to the foreign agent.

5. The method for reducing a packet ordering time of layer 3 handover of claim 1, wherein the sequence control packet includes a mobile IPv4 Internet protocol based structure.

6. A method for reducing a packet ordering time of layer 3 handover of from a satellite network to a wireless network in a mobile router with multiple interfaces for accessing the satellite network and the wireless network, comprising:
receiving a first packet and a second packet from a home agent of the satellite network through a satellite link;
performing a mobile Internet protocol (MIP) registration procedure for the wireless network with moving from the satellite network to the wireless network;
receiving a sequence control packet from the home agent via a satellite link during an MIP registration procedure;
receiving a third packet from the home agent via a wireless link activated in the wireless network; and
reordering the second and third packets that reach in a reversed sequence on the basis of a reception time of the sequence control packet.

7. The method for reducing a packet ordering time of layer 3 handover of claim 6, wherein the sequence control packet includes header information expressing the sequence control packet.

8. The method for reducing a packet ordering time of layer 3 handover of claim 6, further comprising receiving a location-based trigger signal and a wireless link up trigger signal in the wireless link.

9. The method for reducing a packet ordering time of layer 3 handover of claim 8, further comprising transmitting a registration request message to the foreign agent and receiving a registration response message from the foreign agent.

10. A mobile satellite terminal, comprising:
a satellite network interface forming a satellite link for transmission and reception of data in a satellite network and a wireless network interface forming a wireless link for transmission and reception of data in a wireless network;
a controller connected to the satellite network interface and the wireless network interface and processing the transmission and reception data in the satellite link or the wireless link; and
a sequence control determinator detecting a sequence control packet received from the satellite network interface in handover of from the satellite network to the wireless network,
wherein the controller reorders packet data which are received in a reverse sequence through the satellite network and the wireless network on the basis of a reception time of the sequence control packet.

11. The mobile satellite terminal of claim 10, wherein the sequence control determinator includes:
a network handover determining unit determining the handover; and
a sequence control packet detecting unit detecting the sequence control packet among packet data received in the satellite network interface.

12. The mobile satellite terminal of claim 11, wherein the controller includes a buffer temporarily storing the packet data received from the wireless link during handover of from the satellite network to the wireless network in response to an output signal of the sequence control packet detecting unit.

13. The mobile satellite terminal of claim 12, wherein the controller sequentially processes the packet data stored in the buffer from the reception time of the sequence control packet.

14. The mobile satellite terminal of claim 10, wherein the controller forms a tunnel between the mobile router and the home agent via the wireless link and turns down the satellite link from an activation state to an inactivation state in accordance with a satellite link down trigger signal received from the satellite link.

15. The mobile satellite terminal of claim 14, wherein the controller performs discovery and registration procedures for the foreign agent of the wireless network in accordance with a location-based trigger signal and a wireless link up trigger signal received from the wireless link.

16. The mobile satellite terminal of claim 15, wherein the controller transmits a registration request message to the foreign agent and receives a registration response message from the foreign agent.

17. The mobile satellite terminal of claim 10, further comprising an input/output interface connected to the controller, transmitting the packet data transmitted from the satellite link or the wireless link to a fixed node, receiving the packet data from the fixed node, and transmitting the received packet data to a first or second interface in accordance with a control of the controller.
